(19) United States
(12) Patent Application Publication
(10) Pub. No.: US 2006/0151302 A1
(43) Pub. Date: Jul. 13, 2006

(54) Metering discharge bed for belt-driven roller conveyor

(76) Inventor: Timothy R. Baker, Muskegon, MI (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/268,092

(22) Filed: Nov. 7, 2005

Related U.S. Application Data
(60) Provisional application No. 60/642,206, filed on Jan. 7, 2005.

(51) Int. Cl. B65G 23/04

(52) U.S. Cl. 198/835

(57) ABSTRACT

A metering discharge bed for a belt-driven roller conveyor is provided by a second section of rollers positioned downstream of a first section of rollers, the rollers being carried for rotation between opposed side frames. The rollers in the second section are of the same diameter as those in the first section and include two driven rollers that define the opposite ends of the second section. Each of the driven rollers has a drive roller associated therewith which is selectively engageable with the drive belt and has the same diameter as the rollers in the first and second section. Each of the drive rollers has a collar of a diameter greater than that of the rollers in the first and second section, and is linked to its driven roller by at least one belt trained about the driven roller and the collar. Consequently, when the drive rollers of the second section are engaged by the drive belt, the driven rollers in the second section are driven at a rotational speed greater than the rollers in the first section that is proportional to a ratio of the diameter of the collar to the diameter of the rollers.

### CROSS-REFERENCE TO RELATED APPLICATION

This application claims the benefit of the filing date of U.S. Provisional Application Ser. No. 60/642,206, filed Jan. 7, 2005.

### BACKGROUND OF THE INVENTION

The present application relates to a metering or index discharge bed for use with a belt-driven roller conveyor.

With reference to FIG. 1 of the drawings, a simplified section of a typical belt-driven roller conveyor, generally designated 10, is shown. The conveyor section 10 includes a pair of parallel side frame members 12 that support a plurality of rollers 14. The rollers 14 are driven from underneath by frictional engagement with a drive belt 16. The drive belt 16 is supported on its underside by a series of guide rollers 18 (best seen in FIGS. 4 and 5) spaced along the length of the conveyor 10.

Typically, when off-loading a product from a conveyor onto, e.g., a pallet, a specific number of items need to be discharged for each pallet. Oftentimes, after the items have been accumulated on the conveyor prior to discharging, there is inadequate spacing between the items to permit them to be counted by, e.g., a photoeye. Specifically, in order for the conveyed items to be counted, they must be adequately separated. Additionally, after the predetermined number of items have been discharged, the discharge bed needs to be substantially instantaneously stopped while further product is being accumulated.

Accordingly, it is an object of the present invention to provide a discharge bed for a belt-driven roller conveyor that operates to properly space conveyed articles.

### SUMMARY OF THE INVENTION

This object, as well as others that will become apparent upon reference to the following detailed description and accompanying drawings, is accomplished by providing a belt-driven roller conveyor in which a first section of rollers are carried for rotation between opposed side frames that are driven by an endless rotatable belt adapted to contact the rollers so as to rotate the first section of rollers at a first speed. This comprises a typical belt-driven roller conveyor.

In keeping with one aspect of the invention, a second section of rollers is positioned downstream of the first section of rollers that are also carried for rotation between the opposed side frames. The rollers in the second section are of the same diameter as those in the first section. In addition, the second section of rollers includes two driven rollers that preferably define the opposite ends of the second section. Each of the driven rollers has a drive roller associated therewith. The drive roller has the same diameter as the rollers in the first and second section and is selectively engageable with the drive belt. Each of the drive rollers has a collar of a diameter greater than that of the rollers in the first and second section, and each drive roller is linked to its driven roller by at least one belt trained about the driven roller and the collar. Consequently, when the drive rollers of the second section are engaged by the drive belt, the driven rollers in the second section are driven at a rotational speed greater than the rollers in the first section that is proportional to a ratio of the diameter of the collar to the diameter of the rollers.

Optionally, in keeping with another aspect of the invention, the conveyor system may have a third section of rollers intermediate the first section and the second section. The third section of rollers includes two driven rollers preferably defining opposite ends of the third section, with each of the driven rollers for the third section having a drive roller of a diameter less than the diameter associated with the rollers comprising the third section, the drive roller being selectively engageable with the drive belt. Each of the drive rollers for the third section is linked to its driven roller by at least one belt trained about the driven roller and the drive roller. Consequently, when the drive rollers in the third section are engaged by the drive belt, the driven rollers in the third section are driven at a rotational speed less than the rollers in the first section that is proportional to the ratio of the diameter of the third section drive rollers to the rollers of the first section.

### BRIEF DESCRIPTION OF THE FIGURES OF THE DRAWINGS

FIG. 1 is a partial perspective view of a segment of a conventional belt-driven roller conveyor.

FIG. 2 is a perspective view of a discharge bed according to the present invention, with the conventional roller conveyor being shown in dotted lines.

FIG. 3 is a side view of a conveyor system of FIG. 2.

FIG. 4 is a top view of a conveyor system of FIG. 2, with various of the rollers removed to show detail.

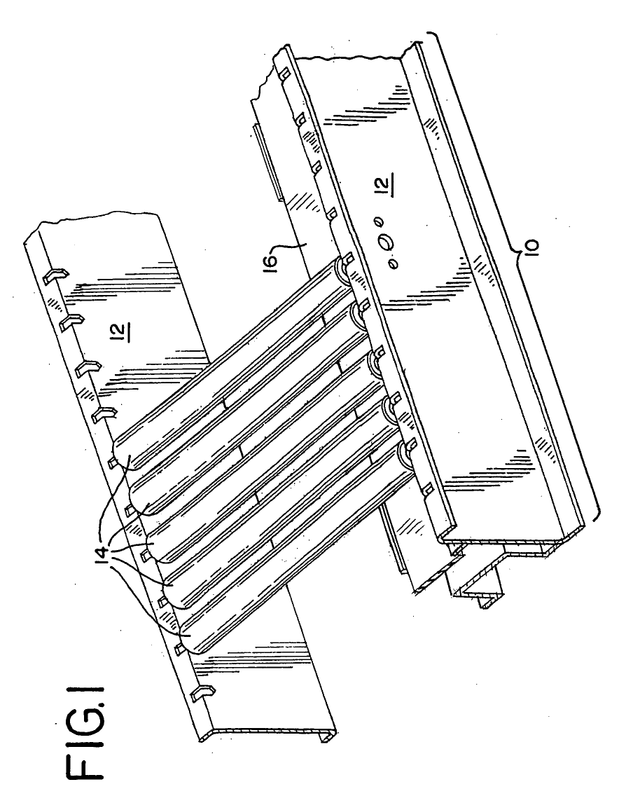

### DETAILED DESCRIPTION OF THE PREFERRED EMBODIMENT

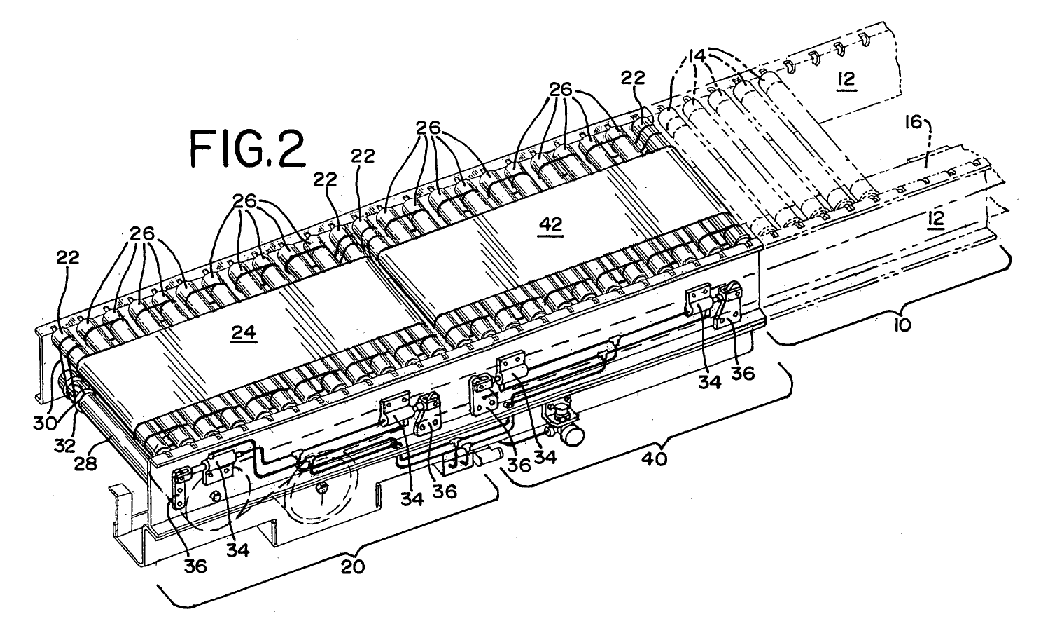

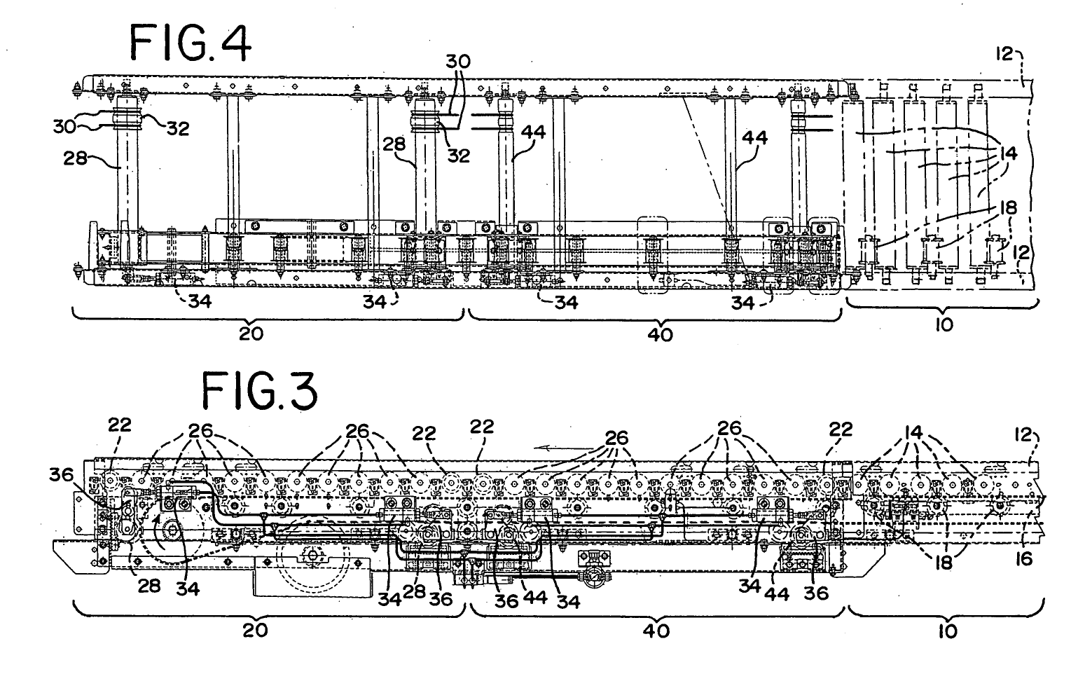

The present invention provides for metered discharge of accumulated articles in the context of a belt-driven roller conveyor. With reference to FIGS. 2-4, a conveyor system is shown including a belt-driven section 10 conventional in the art as described above, and a first section downstream thereof comprising a preferred embodiment of a discharge bed, generally designated 20. The discharge bed 20 has a driven roller 22 preferably at each end thereof, about which a belt 24 is entrained for conveying articles on the discharge bed. While a single belt is shown, a plurality of narrow belts could be used, depending upon the nature of the items being conveyed, without departing from the invention. A plurality of rollers 26 are disposed between the two driven rollers 22. These intermediate rollers 26 freely rotate and are preferably slave-driven off the driven rollers 22. Underlying each driven roller 22 is a drive roller 28 having generally the same diameter as the driven rollers 14, 26 in the remainder of the conveyor, the drive rollers 28 being engaged by the same drive belt 16 that powers the conveyor rollers 14. A belt 30 connects the drive rollers 28 for the discharge bed to the driven rollers 22 in order to rotate the same.

In keeping with the invention, the drive rollers include a pulley or collar 32 that is oversized with respect to the driven roller 22 overlying it, in order to increase the speed of the conveying belt 24 in the discharge bed relative to section 10 of the conveyor. The pulley 32 receives the belt 30 connecting the driven rollers 22 of the discharge bed to their respective drive roller 28. In the illustrated embodiment, the pulley 32 has two grooves, corresponding to two grooves in the driven roller 22 of the discharge bed, and a pair of round belts 30 (typically made of urethane) connect the driven roller 22 to its associated drive roller 28. In the preferred embodiment, the pulley 32 on the drive roller 28 is approximately twice the diameter of the drive roller. Thus, the driven roller 22 will rotate at approximately twice the speed as both the drive rollers 28, as well as twice the speed of the rollers 14 on the section 10 of the conveyor. Consequently, the belts 24 in the discharge bed will move conveyed items at twice the speed that they are traveling when they leave section 10 of the conveyor.

As best seen in FIGS. 2-4, each drive roller 28 for the discharge bed section 20 is moveable into and out of engagement with the drive belt 16 for the conveyor by a double-acting actuator 34 mounted externally to the frame members 12 to activate the discharge bed. The actuator 34 is preferably a hydraulic or pneumatic cylinder, but may be, e.g., an electro-mechanical device without departing from the present invention. Specifically, one end of the axle of each of the drive rollers 28 is journaled in a lever 36 pivotably secured to the side frame 12 and to which the piston rod of each actuator 34 is connected. When the actuators 34 are activated so as to bring the drive rollers 28 into engagement with the drive belt 16, the axles of the drive rollers will be perpendicular to the side frames 12.

A braking device is preferably incorporated into the system so that rotation of the drive rollers can be arrested when the drive belt is disengaged. To this end, when the drive roller 28 is moved out of engagement with the drive belt, it is moved into engagement with a brake pad to halt the movement of the belts 24.

In certain circumstances, a two-stage metering discharge bed may be required to insure proper spacing of the conveyed articles. As shown in FIGS. 2-4, a second stage 40 is located intermediate the stage 20 and section 10 of the conveyor upstream thereof. Like stage 20 of the discharge bed, stage 40 utilizes a single wide conveyor belt 42, but could alternatively utilize a plurality of narrow belts 24 as described above. In other aspects, stage 40 of the discharge bed is substantially similar to the stage 20, except for the difference noted below, and thus the same reference numerals will be used as appropriate.

In stage 40 of the discharge bed, the conveyor belt 42 moves at a slower speed than the conveyed products are moving when they enter the first stage 40. This essentially closes any gaps between the conveyed articles before they enter the second stage 20 of the discharge bed. The use of the two stages 20, 40 helps to insure uniform spacing of the conveyed articles as they exit the second stage 20. To this end, the first stage 40 has drive rollers 44 corresponding to the drive rollers 28 of the discharge bed 20, except that they have a smaller diameter than the driven rollers 14 in section 10 of the conveyor, thus decreasing the speed of its associated conveyor belt 44 relative to the driven rollers 14. The drive rollers 44 are moved into and out of engagement with the drive belt by double-acting actuators 34 in the same manner as described above, and a braking device may be employed to arrest the rotation of the drive rollers 44, also as described above.

Thus, a metering discharge bed for a belt-driven roller conveyor has been provided that meets the objects of the present invention. While the invention has been described in terms of a preferred embodiment, there is not intent to limit it to the same. For example, in the preferred embodiment, each of the two metering discharge beds is described as having a driven roller at each end. However, it is conceivable that each of the discharge beds could utilize a single driven roller off of which all the other rollers are slave-driven. Thus, it is intended that the invention be defined by the scope of the appended claims.

1. A discharge bed for use with a belt-driven roller conveyor system comprising opposed side frames, a first section of rollers carried for rotation between the opposed side frames each roller in the first section being of a first diameter, and an endless rotatable drive belt adapted to contact the rollers in the first section so as to rotate the first section of rollers at a first speed; the discharge bed comprising:
a second section of rollers carried for rotation between opposed side frames, the rollers in the second section also being of the first diameter, the second section of rollers comprising two driven rollers that define opposite ends of the second section, each of the driven rollers having a drive roller associated therewith, the drive rollers being the first diameter and selectively engageable with the drive belt, each drive roller having a collar associated therewith of a second diameter greater than the first diameter, each drive roller being linked to its driven roller by at least one belt trained about the driven roller and the collar associated with the drive roller, whereby when the drive rollers of the second section are engaged by the drive belt the driven rollers in the second section are driven at a rotational speed greater than the rollers in the first section proportional to a ratio of the second diameter to the first diameter.

2. The discharge bed of claim 1 further comprising a third section of rollers intermediate the first section of rollers and the second section of rollers, the rollers comprising the second section also being of the first diameter and carried for rotation between opposed side frames, the third section of rollers comprising two driven rollers defining opposite ends of the third section, each of the two driven rollers of the third section having a drive roller associated therewith of a third diameter less than the first diameter that is selectively engageable with the drive belt, each of the drive rollers for the third section being linked to its driven roller by at least one belt trained about the driven roller and the drive roller, whereby when the drive rollers in the third section are engaged by the drive belt the driven rollers in the third section are driven at a rotational speed less than the rollers in the first section proportional to the ratio of the third diameter to the first diameter.

3. The discharge bed of claim 1 in which the rollers of the second section intermediate the driven rollers are slave driven off the driven rollers of the second section.

4. The discharge bed of claim 2 or claim 3 in which the rollers of the third section intermediate the driven rollers are slave driven off the driven rollers of the third section.

5. The discharge bed of claim 1 wherein the second section of rollers support at least one belt for supporting items conveyed on the second section.

6. The discharge bed of claim 2 or claim 5 wherein the rollers of the third section carry at least one belt for supporting items conveyed on the third section.

7. The discharge bed of claim 2 wherein the drive rollers of each of the second and third sections are moveable from a first position in which the drive belt is spaced from the drive rollers to a second position in which the drive rollers are brought into contact with the drive belt.

8. The discharge bed of claim 7 further comprising brake pads corresponding to each drive roller that are supported by the side frames, the drive rollers contacting the brake pads when in the first position.

9. A belt-driven roller conveyor system comprising:
opposed side frames;
a first section of rollers carried for rotation between the opposed side frames each roller in the first section being of a first diameter; an endless rotatable drive belt adapted to contact the rollers in the first section so as to rotate the first section of rollers at a first speed; and
a second section of rollers carried for rotation between opposed side frames, the rollers in the second section also being of the first diameter, the second section of rollers comprising two driven rollers that define opposite ends of the second section, each of the driven rollers having a drive roller associated therewith, the drive rollers being the first diameter and selectively engageable with the drive belt, each drive roller having a collar associated therewith of a second diameter greater than the first diameter, each drive roller being linked to its driven roller by at least one belt trained about the driven roller and the collar associated with the drive roller, whereby when the drive rollers of the second section are engaged by the drive belt the driven rollers in the second section are driven at a rotational speed greater than the rollers in the first section proportional to a ratio of the second diameter to the first diameter.

10. The conveyor system of claim 9 further comprising a third section of rollers intermediate the first section of rollers and the second section of rollers, the rollers comprising the second section also being of the first diameter and carried for rotation between the opposed side frames, the third section of rollers comprising two driven rollers defining opposite ends of the third section, each of the two driven rollers of the third section having a drive roller associated therewith of a third diameter less than the first diameter that is selectively engageable with the drive belt, each of the drive rollers for the third section being linked to its driven roller by at least one belt trained about the driven roller and the drive roller, whereby when the drive rollers in the third section are engaged by the drive belt the driven rollers in the third section are driven at a rotational speed less than the rollers in the first section proportional to the ratio of the third diameter to the first diameter.

11. The conveyor system of claim 9 in which the rollers of the second section intermediate the driven rollers are slave driven off the driven rollers of the second section.

12. The conveyor system of claim 10 or claim 11 in which the rollers of the third section intermediate the driven rollers are slave driven off the driven rollers of the third section.

13. The conveyor system of claim 9 wherein the second section of rollers support at least one belt for supporting items conveyed on the second section.

14. The conveyor system of claim 10 or claim 13 wherein the rollers of the third section carry at least one belt for supporting items conveyed on the third section.

15. The conveyor system of claim 10 wherein the drive rollers of each of the second and third sections are moveable from a first position in which the drive belt is spaced from the drive rollers to a second position in which the drive rollers are brought into contact with the drive belt.

16. The conveyor system of claim 15 further comprising brake pads corresponding to each drive roller that are supported by the side frames, the drive rollers contacting the brake pads when in the first position.

17. A discharge bed for use with a belt-driven roller conveyor system comprising opposed side frames, a first section of rollers carried for rotation between the opposed side frames each roller in the first section being of a first diameter, and an endless rotatable drive belt adapted to contact the rollers in the first section so as to rotate the first section of rollers at a first speed; the discharge bed comprising:
a second section of rollers carried for rotation between opposed side frames, the rollers in the second section also being of the first diameter, the second section of rollers comprising at least one driven roller having a drive roller associated therewith, the drive roller being the first diameter and selectively engageable with the drive belt, the drive roller having a collar associated therewith of a second diameter greater than the first diameter and being linked to its driven roller by at least one belt trained about the driven roller and the collar associated with the drive roller, whereby when the drive roller of the second section is engaged by the drive belt the driven roller in the second section is driven at a rotational speed greater than the rollers in the first section proportional to a ratio of the second diameter to the first diameter.

18. The discharge bed of claim 17 further comprising a third section of rollers intermediate the first section of rollers and the second section of rollers, the rollers comprising the second section also being of the first diameter and carried for rotation between opposed side frames, the third section of rollers comprising at least one driven roller, the driven roller of the third section having a drive roller associated therewith of a third diameter less than the first diameter that is selectively engageable with the drive belt, the drive roller for the third section being linked to its driven roller by at least one belt trained about the driven roller and the drive roller, whereby when the drive rollers in the third section is engaged by the drive belt the driven roller in the third section is driven at a rotational speed less than the roller in the first section proportional to the ratio of the third diameter to the first diameter.

19. The discharge bed of claim 17 in which the rollers of the second section are slave driven off the driven roller of the second section.

20. The discharge bed of claim 18 or claim 19 in which the rollers of the third section are slave driven off the driven roller of the third section.

21. The discharge bed of claim 17 wherein the second section of rollers support at least one belt for supporting items conveyed on the second section.

22. The discharge bed of claim 18 or claim 19 wherein the rollers of the third section carry at least one belt for supporting items conveyed on the third section.

23. The discharge bed of claim 18 wherein the drive rollers of each of the second and third sections are moveable from a first position in which the drive belt is spaced from the drive rollers to a second position in which the drive rollers are brought into contact with the drive belt.

24. The discharge bed of claim 23 further comprising brake pads corresponding to each drive roller that are supported by the side frames, the drive rollers contacting the brake pads when in the first position.
